(19) United States
(12) Patent Application Publication
(10) Pub. No.: US 2008/0281025 A1
(43) Pub. Date: Nov. 13, 2008

(54) HYBRID POLYISOCYANATES

(75) Inventors: Arno Nennemann, Bergisch Gladbach (DE); Steffen Hofacker, Odenthal (DE); Markus Mechtel, Bergisch Gladbach (DE); Thomas Klimmasch, Leverkusen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/116,571

(22) Filed: May 7, 2008

(30) Foreign Application Priority Data
May 9, 2007 (DE) 102007021621.3

(51) Int. Cl. C08K 5/541; C08K 5/00

(52) U.S. Cl. 524/261; 524/81

(57) ABSTRACT

The present invention relates to hybrid organic-inorganic polyisocyanates for the preparation of organic-inorganic coating compositions and adhesives.

### RELATED APPLICATION

This application claims benefit to German Patent Application No. 10 2007 021 621.3 filed May 9, 2007, the disclosure of which is incorporated by reference in its entirety.

### FIELD OF THE INVENTION

The present invention relates to hybrid organic-inorganic polyisocyanates for the preparation of organic-inorganic coating compositions and adhesives.

### BACKGROUND AND PRIOR ART

Attempts are made through the synthesis of organic-inorganic hybrid materials to combine typical properties of organic and inorganic substances in one material. Thus, for example, glasses are distinguished by their great hardness and acid resistance, while organic polymers represent highly elastic materials. Over time, a wide variety of organic-inorganic hybrid materials have become known, which on the one hand are much harder than pure organic polymers and yet do not have the brittleness of purely inorganic materials.

Hybrid materials are classed into different types according to the manner and mode of the interaction between organic and inorganic component. A review of this is found in J. Mater. Chem. 6 (1996) 511.

One class of hybrid materials is obtained by the hydrolysis and condensation of (semi-)metal alkoxy compounds such as Si(OEt)₄, for example, forming an inorganic network which with conventional organic polymers, such as polyesters or polyacrylates, for example, constitutes a mixture whose polymer strands develop a mutual penetration (“interpenetrating network”). There is no covalent chemical attachment of the one network to the other; instead the interactions, if there are any at all, are no more than weak (such as, for example, van der Waals bonds or hydrogen bonds). Hybrid materials of this kind are described for example in WO 93/01226 and WO 98/38251.

WO 98/38251 teaches that transparent hybrid materials are obtainable through mixtures of at least one organic polymer, inorganic particles, an organic-inorganic binder, and solvent. Examples 8-10 describe mixtures which are distinguished as a hybrid coating in their hardness, optical transparency and crack-free application, for example. Of great importance in addition to the properties described therein is—particularly in the field of topcoat coating for the exterior sector—the outdoor weathering stability, in other words the resistance to UV light under simultaneous influence of climatic conditions. This is not satisfactorily solved by the systems described in WO 98/38251. Moreover, no hybrid polyisocyanates are described.

DE 10 2004 048874 discloses hybrid compositions based on an inorganic binder, metal alkoxides, inorganic UV absorbers and an organic polyol. In one example the crosslinking of such systems is carried out with blocked polyisocyanates. In contrast, there is no disclosure or reference to the advantages of polyol-free mixtures of the blocked polyisocyanate with the inorganic components. As compared with existing systems, the systems described in DE 10 2004 048874 do exhibit improved weathering stability and acid resistance, and also higher scratch resistances, but their storage stabilities and also their solvent resistance and chemical resistance are unsatisfactory.

It has been found, surprisingly, that mixtures of blocked polyisocyanates and inorganic binder components which are free of organic polyols have the required storage stability and, when crosslinked with organic polyols, lead to coatings with considerably improved characteristics.

### SUMMARY OF THE INVENTION

The present invention provides hybrid polyisocyanate compositions free from organic polyols and comprising
A) an inorganic binder based on polyfunctional organosilanes which contain at least 2 silicon atoms having in each case 1 to 3 alkoxy or hydroxyl groups, the silicon atoms being attached by in each case at least one Si—C bond to a structural unit linking the silicon unit,
B) (semi-)metal alkoxides and their hydrolysis and condensation products,
C) ZnO and/or CeO₂ particles as inorganic UV absorbers at least 90% of which have an average particle size as measured by ultracentrifuge of ≦50 nm,
D) blocked organic polyisocyanates.

### DESCRIPTION OF PREFERRED EMBODIMENTS

Inorganic binders of component A) are polyfunctional organosilanes which contain at least 2, preferably at least 3 silicon atoms having in each case 1 to 3 alkoxy or hydroxyl groups, the silicon atoms being attached by in each case at least one Si—C bond to a structural unit linking the silicon atoms.

Examples of linking structural units in the sense of the invention include linear or branched C₁ to C₁₀ alkylene chains, C₅ to C₁₀ cycloalkylene radicals, aromatic radicals, such as phenyl, naphthyl or biphenyl, or else combinations of aromatic and aliphatic radicals. The aliphatic and aromatic radicals may also contain heteroatoms, such as Si, N, O, S or F.

Examples of polyfunctional organosilanes are compounds of the general formula (I)

R¹₄₋ᵢSi[(CH₂)ₙSi(OR²)ₐR³₃₋ₐ]ᵢ (I)

where
i=2 to 4, preferably i=4,
n=1 to 10, preferably n=2 to 4, more preferably n=2
R¹=alkyl, aryl
R²=alkyl, aryl, preferably R²=methyl, ethyl, isopropyl
R³=alkyl, aryl, preferably R³=methyl
a=1 to 3; where a=1 and R² can also denote hydrogen.

Further examples of polyfunctional organosilanes are cyclic compounds of the general formula (II)

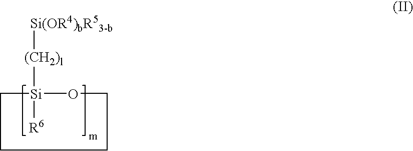

where
m=3 to 6, preferably m=3 or 4
1=2 to 10, preferably 1=2
R⁴ alkyl, aryl, preferably R⁴=methyl, ethyl, isopropyl
R⁵=alkyl, aryl, preferably R⁵=methyl
R⁶═C₁-C₆ alkyl or C₆-C₁₄ aryl, preferably R⁶=methyl, ethyl, more preferably R⁶=methyl
b=1 to 3; where b=1 and R⁴ can also denote hydrogen.

Further examples of polyfunctional organosilanes are compounds of the general formula (III)

Si[OSiR⁷₂(CH₂)ₚSi(OR⁸)_{c}R⁹_{3-c}]₄ (III)

where p=1 to 10, preferably p=2 to 4, more preferably p=2,
R⁷=alkyl, aryl, preferably R⁷=methyl
R⁸=alkyl, aryl, preferably R⁸=methyl, ethyl, isopropyl
R⁹=alkyl, aryl, preferably R⁹=methyl
c=1 to 3; where c=1 and R⁸ may also denote hydrogen.

Further possible examples of polyfunctional organosilanes, silanols and/or alkoxides include:

### a.) Si[(CH₂)₂Si(OH)(CH₃)₂]₄

b.) cyclo-{OSiMe[(CH₂)₂Si(OH)Me₂]}₄
c.) cyclo-{OSiMe[(CH₂)₂Si(OEt)₂Me]}₄
d.) cyclo-{OSiMe[(CH₂)₂Si(OMe)Me₂]}₄
e.) cyclo-{OSiMe[(CH₂)₂Si(OEt)₃]}₄.

It is likewise possible to employ the oligomers, i.e. the hydrolysis and condensation products, of the aforementioned compounds and of compounds of the formulae (I), (II) and/or (III).

With particular preference the inorganic binders of component A) are based on cyclo-{OSiMe[(CH₂)₂Si(OH)Me₂]}₄ and/or cyclo-{OSiMe[(CH₂)₂Si(OEt)₂Me]}.

(Semi-)metal alkoxides of component B) conform to the general formula (IV)

R¹⁰_{x-y}M(OR¹¹)_{y} (IV)

where
R¹⁰, R¹¹: are independently of one another alkyl or aryl groups, preferably methyl, ethyl, isopropyl, n-butyl, sec-butyl, tert-butyl or phenyl groups, more preferably methyl or ethyl groups, and
the variables M, x and y are either
M=Si, Sn, Ti or Zr with x=4 and y=1 to 4 or
M=B or Al with x=3 and y=1 to 3.

Examples are Si(OEt)₄, Si(OMe)₄, H₃C—Si(OEt)₃, H₃C—Si(OMe)₃, B(OEt)₃, Al(OⁱPr)₃, or Zr(OⁱPr)₄. In the sense of the invention it is also possible, instead of the monomeric alkoxides, to use their hydrolysis and condensation products. Available commercially, for example, are Si(OEt)₄-condensates.

Particular preference is given to using in component B) Si(OEt)₄ and its hydrolysis and/or condensation products.

The inorganic UV absorbers of component C) preferably have an average particle size of ≦30 nm.

Preferably at least 98%, with particular preference at least 99.5%, of all the particles used have the required average particle size.

These inorganic UV absorbers may be used not only in solid form but preferably in the form of dispersions (sots). Solvents which can be used in this case include not only water, aqueous acids or bases but also organic solvents or mixtures thereof.

Particular preference is given to using in C) dispersions (sols) of ZnO and/or CeO₂, with very particular preference acid-stabilized dispersions (sots) of CeO₂ of the aforementioned size ranges.

The blocked polyisocyanates of component D) are based on the NCO-functional compounds, known per se to the skilled person, that have more than one NCO group per molecule. These compounds preferably have NCO functionalities of 2.3 to 4.5, NCO group contents of 11.0% to 24.0% by weight and monomeric diisocyanate contents of less than 1% by weight, preferably less than 0.5% by weight.

Polyisocyanates of this kind are obtainable by modifying simple aliphatic, cycloaliphatic, araliphatic and/or aromatic diisocyanates and may have uretdione, isocyanurate, allophanate, biuret, iminooxadiazinedione and/or oxadiazinetrione structures. Additionally it is possible to use such polyisocyanates as NCO-containing prepolymers. Polyisocyanates of this kind are described for example in Laas et al. (1994), J. prakt. Chem. 336, 185-200 or in Bock (1999), Polyurethane für Lacke und Beschichtungen, Vincentz Verlag, Hannover, pp. 21-27.

Suitable diisocyanates for preparing such polyisocyanates are any desired diisocyanates, obtainable through phosgenation or by phosgene-free methods, as for example by thermal urethane cleavage, of the molecular weight range 140 to 400 g/mol containing aliphatically, cycloaliphatically, araliphatically and/or aromatically attached isocyanate groups, such as 1,4-diisocyanatobutane, 1,6-diisocyanatohexane (HDI), 2-methyl-1,5-diisocyanatopentane, 1,5-diisocyanato-2,2-dimethylpentane, 2,2,4- and/or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethyl-cyclohexane (isophorone diisocyanate, IPDI), 4,4′-diisocyanatodicyclohexylmethane, 1-isocyanato-1-methyl-4(3)-isocyanatomethylcyclohexane, bis(isocyanatomethyl)norbornane, 1,3- and 1,4-bis(1-isocyanato-1-methylethyl)benzene (TMXDI), 2,4- and 2,6-diisocyanatotoluene (TDI), 2,4′- and 4,4′-diisocyanatodiphenylmethane (MDI), 1,5-diisocyanatonaphthalene or any desired mixtures of such diisocyanates.

The blocking of the aforementioned NCO functional compounds is carried out according to methods which are established per se in the art (Houben Weyl, Methoden der organischen Chemie XIV/2, pp. 61-70).

For this purpose, the isocyanates to be blocked are reacted with one or with a mixture of two or more blocking agents.

Suitable blocking agents include all compounds which when the blocked (poly)isocyanate is heated can be eliminated, where appropriate with the presence of a catalyst. Suitable blocking agents are, for example, sterically bulky amines such as dicyclohexylamine, diisopropylamine, N-tert-butyl-N-benzylamine, caprolactam, butanone oxime, imidazoles with the various conceivable substitution patterns, pyrazoles such as 3,5-dimethylpyrazole, triazoles and tetrazoles, and also alcohols such as isopropanol, ethanol, methyl ethyl ketoxime, malonic esters.

Besides this there is also the possibility of blocking the isocyanate group in such a way that in the event of an ongoing reaction the blocking agent is not eliminated but instead the intermediate formed intermediately is consumed by reaction. This is the case in particular with cyclopentanone-2-carboxyethyl ester, which in the thermal crosslinking reaction is incorporated fully by reaction into the polymeric network and is not eliminated again.

Preferred blocking agents are butanone oxime, caprolactam, malonic esters, diisopropylamine, cyclopentanone-2-carboxyethyl(methyl) ester, isopropanol and mixtures thereof.

The blocked polyisocyanates of component D) are preferably based on IPDI, MDI, TDI, 4,4′-diisocyanatodicyclohexylmethane, HDI and mixtures thereof. They are more preferably based on IPDI and/or HDI.

To adjust the viscosity of the hybrid polyisocyanate compositions of the invention it is also possible, in addition to components A) to D), to add organic solvents. Examples are alcohols, such as methanol, ethanol, isopropanol, 2-butanol, 1,2-ethanediol or glycerol, ketones, such as acetone, methyl ethyl ketone, methyl isobutyl ketone or butanone, esters, such as ethyl acetate or methoxypropyl acetate, aromatics, such as toluene or xylene, ethers, such as tert-butyl methyl ether, and aliphatic hydrocarbons.

Preference is given to polar solvents and particular preference to using alcohols of the aforementioned kind.

Particular preference is given to using solvent mixtures with alcohol and/or ester fractions of more than 50% by weight, with particular preference of more than 80% by weight.

The amount of the solvents is preferably chosen such that the solids content of the composition lies 5% to 75% by weight, with particular preference 20% to 55% by weight.

The hybrid polyisocyanate compositions of the invention may, furthermore, also comprise catalysts which serve to accelerate the hydrolysis and condensation reactions. Catalysts which can be used include organic and inorganic acids and bases and also organometallic compounds, fluoride compounds or else metal alkoxides. Examples that may be mentioned include the following: acetic acid, p-toluenesulphonic acid, hydrochloric acid, sulphuric acid, ammonia, dibutylamine, potassium hydroxide, sodium hydroxide, ammonium fluoride, sodium fluoride, or aluminium isopropoxide.

In one preferred embodiment of the invention the hybrid polyisocyanate compositions of the invention, based on components A) to D), have a composition of
1% to 40% by weight of inorganic binder A),
10% to 80% by weight of (semi-)metal alkoxides B),
0.1% to 20% by weight of inorganic UV absorbers C) and
5% to 70% by weight of blocked polyisocyanate D),
   the ingredients A) to D) adding up to 100% by weight.

In one particularly preferred embodiment of the invention the hybrid polyisocyanate compositions of the invention, based on components A) to D), have a composition of
5% to 30% by weight of inorganic binder A),
20% to 65% by weight of (semi-)metal alkoxides B),
0.2% to 10% by weight of inorganic UV absorbers C) and
10% to 50% by weight of blocked polyisocyanate D),
   the ingredients A) to D) adding up to 100% by weight.

The hybrid polyisocyanate compositions of the invention are typically prepared by first introducing components A) and B) and also, where appropriate, fractions of organic solvent and then, where appropriate, carrying out (partial) hydrolysis by addition of acid, and finally adding component C) and, where appropriate, further organic solvents with stirring and, where appropriate, with cooling. The is followed by the addition of component D).

In this case the inorganic UV absorbers C) are incorporated into the composition of the invention preferably by stirred incorporation into component A) and/or B) of the invention. Stirred incorporation into the organic polyisocyanate component is not preferred.

The present invention further provides polyurethane systems, useful for example as coating compositions, which comprise at least
a) one of the above-described hybrid polyisocyanate compositions and also
b) at least one polyol or polyamine.

Such polyurethane systems of the present invention comprise polyhydroxy compounds and/or polyamine compounds for crosslinking. The systems may also contain other polyisocyanates, different from the polyisocyanates of the invention, and also auxiliaries and additives present.

Examples of suitable polyhydroxyl compounds are trifunctional and/or tetrafunctional alcohols and/or the polyether polyols, polyester polyols and/or polyacrylate polyols that are typical per se in coatings technology.

Furthermore, for the crosslinking, it is also possible to use polyurethanes or polyureas which are crosslinkable with polyisocyanates by virtue of the active hydrogen atoms present in the urethane or urea groups respectively.

Likewise possible is the use of polyamines, whose amino groups may have been blocked, such as polyketimines, polyaldimines or oxazolanes.

For the crosslinking of the polyisocyanates of the invention it is preferred to use polyacrylate polyols and polyester polyols.

As catalysts for the reaction of the compositions of the invention with the polyisocyanates it is possible to use catalysts such as commercially customary organometallic compounds of the elements aluminium, tin, zinc, titanium, manganese, iron, bismuth or else zirconium such as, for example, dibutyltin laurate, zinc octoate, titanium tetraisopropoxide. Suitability is furthermore also possessed, however, by tertiary amines such as 1,4-diazabicyclo[2.2.2]octane, for example.

A further possibility is to accelerate the reaction of the polyols and/or polyamines from b) with the compositions of the invention from a) by carrying out this reaction at temperatures between 20 and 200° C., preferably between 60 and 180° C., with particular preference between 70 and 150° C.

The ratio of a) to b) is set such as to result in an NCO/OH ratio of the free and, where appropriate, blocked NCO groups of a) to the OH groups of component b) of 0.3 to 2, preferably 0.4 to 1.5, with particular preference 0.5 to 1.0.

In blends with the auxiliaries that are typical in coatings technology, such as organic or inorganic pigments, further organic light stabilizers, free-radical scavengers, coatings additives, such as dispersing, flow-control, thickening, defoaming and other auxiliaries, adhesives, fungicides, bactericides, stabilizers or inhibitors and further catalysts, it is possible, from the composition of the invention, more particularly in the form of the coating compositions of the invention, to produce highly resistant coatings for carmaking.

Furthermore, the coating compositions of the invention may also find application in the fields of coating plastics, coating floors and/or coating wood/furniture.

### EXAMPLES

All percentages, unless indicated otherwise, refer to percent by weight.

Cyclo-{OSiMe[(CH₂)₂Si(OEt)₂Me]}₄ (D4 diethoxide) was prepared as described in Example 2 in WO 98/38251.
Desmodur® BL 3175 SN: blocked HDI trimer, blocking agent butanoneoxime, blocked NCO content 11.1%, solids 75% in SN 100, equivalent weight 378, viscosity 3300 mPas at 23° C., commercial product of Bayer MaterialScience AG, Leverkusen, Del.
Desmodur BL 3272 MPA: blocked HDI trimer, blocking agent s-caprolactam, blocked NCO content 10.1%, solids 72% in MPA, equivalent weight 410, viscosity about 2700 mPas at 23° C., commercial product of Bayer MaterialScience AG, Leverkusen, Del.
Desmophen® A870: polyacrylate polyol, 70% in butyl acetate, OH number 97, OH content 2.95%, viscosity at 23° C. about 3500 mPas, commercial product of Bayer MaterialScience AG, Leverkusen, Del.
Desmophen A665 BA: polyacrylate polyol, 70% in butyl acetate, OH content 3.2%, viscosity at 23° C. about 3500 mPas, commercial product of Bayer MaterialScience AG, Leverkusen, Del.
Baysilone® coatings additive OL 17: flow control assistant, 100% as-supplied form (Borchers GmbH, Langenfeld, Germany)
BYK® 070: defoamer, 10% strength in MPA/BA/xylene as-supplied form. (BYK-Chemie GmbH, Wesel, Germany)
Modaflow: flow control assistant, 100% as-supplied form (Cytec, Surface Specialties, Werndorf near Graz, Austria)
Tinuvin® 123: free-radical scavenger, 100% as-supplied form (Ciba Spezialitätenchemie Lampertheim GmbH, Lampertheim, Germany)
Tinuvin® 384-2: UV stabilizer, 100% as-supplied form (Ciba Spezialitätenchemie Lampertheim GmbH, Lampertheim, Germany)
Tinuvin® 292: free-radical scavenger, 100% as-supplied form (Ciba Spezialitätenchemie Lampertheim GmbH, Lampertheim, Germany)
MPA/SN mixture: 1:1 mixture of 1-methoxypropyl acetate and solvent naphtha 100 (Kraemer&Martin GmbH, St. Augustin, Germany)
DBTL: >97% as-supplied form (dibutyltin dilaurate, Brenntag AG, Mülheim/R., Germany)
Pendulum damping (König) according to DIN EN ISO 1522 “Pendulum damping test”
Chemical resistance according to DIN EN ISO 2812-5 “Coating materials—determination of resistance to liquids—Part 5: Method with the gradient oven”. The chemicals is reported in ° C. units. For this purpose, 1% strength sulphuric acid or the corresponding chemicals are sprinkled onto the coating, which is then heated in a gradient oven. The temperature at which visible damage to the coating first occurs is reported in Table 1. The higher this temperature, the more resistant the coating is to the chemical in question.
Scratch resistance, laboratory wash unit (wet scratching) according to DIN EN ISO 20566 “Coating materials—testing of the scratch resistance of a coating system using a laboratory wash unit”. The relative residual gloss in % indicates the level of the gloss [20°] after scratching in accordance with DIN 5668 in comparison to the gloss before scratching. The higher this figure, the better the scratch resistance. The initial gloss prior to scratching was between 87% and 92% for all of the systems.

Determination of solvent resistance This test was used to ascertain the resistance of a cured coating film to various solvents. For this purpose the surface of the coating is exposed to the solvents for a defined time. Subsequently an assessment is made, both visually and by touch with the hand, as to whether and, if so, what changes have occurred on the area under test. The coating film is generally situated on a glass plate; other substrates are likewise possible. The test tube stand with the solvents xylene, 1-methoxyprop-2-yl acetate, ethyl acetate and acetone (see below) is placed on the surface of the coating in such a way that the openings of the test tubes with the cotton-wool plugs are lying on the film. The important factor is the resultant wetting of the surface of the coating by the solvent. After the defined exposure time to the solvents, of 1 minute and 5 minutes, the test tube stand is removed from the surface of the coating. Subsequently the solvent residues are immediately removed by means of an absorbent paper or textile fabric. After cautious scratching with the fingernail, the area under test is then immediately rated visually for changes. The following gradations are differentiated:

| | |
|---|---|
| 0 = unchanged | |
| 1 = trace changed | e.g. only visible change |
| 2 = slightly changed | e.g. softening perceptible with the fingernail |
| | can be found |
| 3 = markedly changed | e.g. severe softening can be found with the |
| | fingernail |
| 4 = severely changed | e.g. with the fingernail down to the substrate |
| 5 = destroyed | e.g. coating surface destroyed without external |
| | action. |

The evaluation gradations found for the solvents indicated above are documented in the following sequence:

| | |
|---|---|
| Example | 0000 (no change) |
| Example | 0001 (visible change only for acetone) |

The numerical sequence here describes the sequence of solvents tested (xylene, methoxypropyl acetate, ethyl acetate, acetone)

Storage stability: To determine the storage stability, the specimens were stored at corresponding temperatures and were regularly inspected for gelling, sedimentation and discoloration.

### Deblocking/Crosslinking Temperature

To measure deblocking temperature, onset of crosslinking, and curing profile for a coating formulation by means of DMA, a woven glass ribbon was clamped into the sample holder and coated with the formulation under test. This dual-cantilever setup was excited with a sinusoidal mechanical vibration, and the temperature was heated at a constant heating rate, starting from room temperature.

| | |
|---|---|
| Instrument | DMA 2980 analyser (TA Instruments) |
| Calibration | Temperature → indium in woven glass fabric |
| Measurement | Dual cantilever clamps, amplitude of deformation |
| | 0.2 mm, excitation 2 Hz. |

### Deblocking/Crosslinking

For the determination of the deblocking temperature the wet 1 K coating materials were coated onto a glass web clamped into the measurement clamps of a sample holder. Curing took place with slow heating to 250° C. (2 K/min heating rate) with sinusoidal deformation at low amplitude and frequency. From the response signal, a relative storage modulus, as a measure of the stiffness of the coating which cures, was derived. Since the geometry of the test specimens changed in the course of heating (evaporation of solvent construction of a network), only a relative storage modulus could be specified.

An evaluation was made of the commencement of crosslinking/deblocking by way of the onset temperature of deblocking (evaluated via tangential section).

### Example 1

### Preparation of the Precursor of the Inventive Composition (Inorganic Precondensate)

Drawing on DE 10 2004 048874 A1, Example 1, a 4 l multi-neck flask was charged with 204.7 g of D4 diethoxide, 1054.1 g of tetraethoxysilane, 309.7 g of ethanol, 929.2 g of 2-butanol and 103.3 g of butyl glycol, this initial charge was homogenized, and then to start with 108.4 g of 0.1 molar hydrochloric acid were added with stirring. After a stirring time of 30 minutes a further 1111.2 g of 0.1 molar hydrochloric acid were added with stirring, followed by stirring for 60 minutes more. Thereafter 56.8 g of cerium dioxide particles (Cerium Colloidal 20%, Rhodia GmbH, Frankfurt/Main, Germany) were added with stirring, and subsequently 55.1 g of 2.5% strength acetic acid were added. After 24 hours of ageing, the inorganic precondensate was processed further. The solids was 20.78% and was concentrated where appropriate by removal of low-boiling components (at 80 mbar and 40° C. water bath temperature on a rotary evaporator under vacuum).

### Example 2

### Preparation of an Inventive Composition

92.3 g of the compound from Example 1 were admixed with 7.7 g of Desmodur BL 3175 SN and the mixture was stirred and then filtered through a 0.45 μm filter. The mixture had a theoretical solids content of 24.95% in 2-butanol/ethanol/SN100 and a theoretical NCO content of 0.85%.

The storage stability was 93 days at RT.

### Example 3

### Preparation of an Inventive Composition

The procedure of Example 2 was repeated, using 67.5 g of the compound from Example 1 and 7.5 g of Desmodur BL 3175 SN. The resulting mixture had a theoretical solids content of 26.3% in 2-butanol/ethanol/SN100 and a theoretical NCO content of 1.1%. The storage stability was 124 days at RT.

### Example 4

### Preparation of an Inventive Composition

The procedure of Example 2 was repeated, using 92.3 g of the compound from Example 1 and 7.7 g of Desmodur BL 3272 MPA. The resulting mixture had a theoretical solids content of 24.7% in 2-butanol/ethanol/MPA and a theoretical NCO content of 0.78%. The storage stability was 91 days at RT.

### Example 5

### Preparation of an Inventive Composition

The procedure of Example 2 was repeated, using 17.1 g of the compound from Example 1 and 5.7 g of Desmodur BL 3272 MPA. The resulting mixture had a theoretical solids content of 34.8% in 2-butanol/ethanol/MPA and a theoretical NCO content of 2.53%. The storage stability was 264 days at RT.

### Performance Testing

The hybrid polyisocyanates of the invention, from Examples 2 to 5, were blended with Desmophen® A870 in the NCO/OH proportions of 1 and 0.5, and also with coatings additives (Table 1), and the blends were stirred thoroughly. The solids contents of the hybrid coating materials were between 30% and 34%, and were adjusted where appropriate using a 1:1 MPA/SN solvent mixture. In the case of stoichiometric curing (NCO/OH=1) of the coating film with hybrid polyisocyanates and also with the comparatives, the catalyst DBTL was added. Before processing, the coating material was deaerated for 10 minutes. The coating material was then applied using a gravity-feed cup-type gun in 1.5 cross-passes to the prepared substrate (3.0-3.5 bar compressed air, nozzle: 1.4-1.5 mm Ø, nozzle-substrate spacing: about 20-30 cm). After a flash-off time of 15 minutes the coating was baked at 140° C. for 30 minutes. The dry film thickness was in each case about 30 μm. After conditioning/ageing at 60° C. for 16 hours, paint testing was commenced. The results are compiled in Table 2.

For the purpose of comparison, a conventional coating system comprising Desmophen® A870 and Desmodur® BL 3175 (Example 10) or Desmodur® BL 3272 MPA (Example 11) and also coatings additives (Table 1) was formulated and applied analogously. The standard 1K PU clearcoats had a solids of approximately 48%, which where appropriate was adjusted using a 1:1 MPA/SN solvent mixture. The results are likewise summarized in Table 2.

TABLE 1
Amounts employed, additives

Hybrid coating materials:
0.2% Baysilone OL 17 (solids/binder solids), used as a 10% strength
solution in MPA
2.0% Byk 070 (as-supplied form/binder solids), used in as-supplied form
(10% strength solution)
1.0% Tinuvin 123 (solids/binder solids), used in as-supplied form (100%)
1.5% Tinuvin 384-2 (solids/binder solids) used in as-supplied form (100%)
About 0.5% DBTL (solids/solids), used as a 10% strength solution in
MPA
Standard 1K PU coating materials:
0.1% Baysilone OL 17 (solids/binder solids), used as a 10% strength
solution in MPA
0.01% Modaflow (solids/binder solids), used 1% in MPA
1.0% Tinuvin 292 (solids/binder solids), used as a 10% strength solution
in MPA
1.5% Tinuvin 384-2 (solids/binder solids), used as a 10% strength solution
in MPA
About 0.5% DBTL (solids/solids), used as a 10% strength solution in
MPA

TABLE 2
Comparison of paint-technology properties

| | Example | | | | | |
|---|---|---|---|---|---|---|
| | 6 | 7 | 8 | 9 | 10 | 11 |
| Hybrid PIC from Ex. | 2 | 3 | 4 | 5 | — | — |
| NCO/OH | 1 | 0.5 | 1 | 0.5 | 1 | 1 |
| König pendulum | 185 | 203 | 190 | 216 | 181 | 182 |
| damping (glass) [s] | | | | | | |
| Solvent resistance | 0011 | 0011 | 0012 | 0011 | 3344 | 4455 |
| (X/MPA/EA/Ac) | | | | | | |
| [rating]¹⁾ after 5 min | | | | | | |
| Chemical resistance | | | | | | |
| (gradient oven) [° C.] | | | | | | |
| Tree resin | >68 | n.b. | >68 | n.b. | 36 | 36 |
| DI water | >68 | n.b. | >68 | n.b. | 51 | 39 |
| H₂S0₄, 1% | 48 | n.b. | 51 | n.b. | 44 | 41 |
| FAM, 10 min [rating]¹⁾ | 0 | n.b. | 0 | n.b. | 0 | 4 |
| Scratch resistance | | | | | | |
| (Amtec Kistler- | | | | | | |
| laboratory wash unit) | | | | | | |
| Relative residual gloss [%] | 87.8 | 72.2 | 85 | 84.6 | 59.1 | 23.5 |
| Deblocking temperature [° C.] | 59 | | 69 | | 141 | 169 |

¹⁾0 = good; 5 = poor

Coatings based on the hybrid polyisocyanates of the invention exhibit distinct improvements in scratch resistance, solvent resistance, pendulum hardness, and resistance to tree resin, sulphuric acid and DI water in comparison to the non-hybrid polyurethane coatings.

### Examples 12-15

### Paint Formulations with Hybrid PICs of the Invention as a Counter-Example to Paint Formulations Based on a Hybrid Polyol Corresponding to De 10 2004 048874

The hybrid polyisocyanates of the invention, from Examples 4 and 5, were blended with Desmophen® A665 in the NCO/OH proportions of 1 and 0.5, and also with coatings additives (Table 1), and the blends were stirred thoroughly. The solids contents of the hybrid coating materials were between 30% and 34%, and were adjusted where appropriate using a 1:1 MPA/SN solvent mixture. Before processing, the coating material was deaerated for 10 minutes. The coating material was then applied using a gravity-feed cup-type gun in 1.5 cross-passes to the prepared substrate (3.0-3.5 bar compressed air, nozzle: 1.4-1.5 mm Ø, nozzle-substrate spacing: about 20-30 cm). After a flash-off time of 15 minutes the coating was baked at 140° C. for 30 minutes. The dry film thickness was in each case about 30 μm. After conditioning/ageing at 60° C. for 16 hours, paint testing was commenced. The results are compiled in Tables 3 and 4.

For the purpose of comparison, a hybrid polyol corresponding to DE 10 2004 048874 (Example 1), based on Desmophen A665, and Desmodur® BL 3272, and also coating additives (Table 1) was formulated and applied analogously. The compositions and results are likewise summarized in Tables 3 and 4.

TABLE 3
Preparation of the coating formulations (comparison DE 10 2004 048874)

Example

| | | | |
|---|---|---|---|
| 12 | 13 | 14 | 15 |

Reactants (in % by weight):

| | | | | |
|---|---|---|---|---|
| Hybrid PIC | 87.7 | 80.2 | — | — |
| | (Ex. 4) | (Ex. 5) | | |
| Desmodur BL 3272 | — | — | 14.5 | 8.4 |
| Desmophen A665 | 9.3 | 16.9 | — | — |
| Hybrid polyol* | — | — | 67.2 | 77.9 |
| NCO/OH | 1 | 0.5 | 1 | 0.5 |

Coatings additives (in % by weight):

| | | | | |
|---|---|---|---|---|
| Baysilon OL17 | 0.33 | 0.35 | 0.4 | 0.4 |
| BYK 070 | 0.6 | 0.65 | 0.75 | 0.75 |
| Tinuvin 123 | 0.33 | 0.35 | 0.4 | 0.4 |
| Tinuvin 384-2 | 0.5 | 0.53 | 0.6 | 0.6 |
| MPA/SN | 1.27 | 1 | 16.1 | 11.55 |

*Hybrid polyol corresponding to Example 1, DE 10 2004 048874

TABLE 4
Comparison of the paint-technology properties of hybrid PICs of the
invention with hybrid polyol from DE 10 2004 048874 (Example 1)

| | Example | | | |
|---|---|---|---|---|
| | | | 12 | 13 |
| | | | Comparative | Comparative |
| | | | from | from |
| | 10 | 11 | DE 10 2004 | DE 10 2004 |
| | Inventive | Inventive | 048874 | 048874 |
| NCO/OH | 1 | 0.5 | 1 | 0.5 |
| König pendulum damping (glass) | 200 | 178 | 109 | 130 |
| [s] | | | | |
| Solvent resistance | 0011 | 0022 | 4455 | 1122 |
| (X/MPA/EA/Ac) [rating]¹⁾ after | | | | |
| 5 min | | | | |
| Scratch resistance (Amtec Kistler- | | | | |
| laboratory wash unit) | | | | |
| Relative residual gloss [%] | 32.9 | 55.6 | 27.8 | 57.2 |

With the same scratch resistance, the coatings based on the hybrid polyisocyanates exhibited higher solvent resistance and pendulum hardness as compared with the hybrid polyols from DE 10 2004 048874 (Example 1).

All documents mentioned herein are incorporated by reference to the extent relevant to making, using or describing the present invention.

1. A hybrid polyisocyanate composition free from organic polyols and comprising
A) an inorganic binder based on polyfunctional organosilanes which contain at least 2 silicon atoms having in each case 1 to 3 alkoxy or hydroxyl groups, the silicon atoms being attached by in each case at least one Si—C bond to a structural unit linking the silicon unit,
B) (semi-)metal alkoxides and/or their hydrolysis and condensation products,
C) ZnO and/or CeO₂ particles as inorganic UV absorbers at least 90% of which have an average particle size as measured by ultracentrifuge of ≦50 nm, and
D) blocked organic polyisocyanates.

2. A hybrid polyisocyanate composition according to claim 1, wherein the inorganic binder of component A) is based on cyclo-{OSiMe[(CH₂)₂Si(OH)Me₂]}₄ and/or cyclo-{OSiMe[(CH₂)₂Si(OEt)₂Me]}₄.

3. A hybrid polyisocyanate composition according to claim 1, wherein component B) is Si(OEt)₄ and/or its hydrolysis and/or condensation products.

4. A hybrid polyisocyanate composition according to claim 1, wherein at least 99.5% of the inorganic UV absorbers of component C) have an average particle size of ≦30 nm.

5. A hybrid polyisocyanate composition according to claim 1, wherein the inorganic UV absorbers of component C) are added in the form of dispersions or sols.

6. A hybrid polyisocyanate composition according to claim 5, wherein acid-stabilized dispersions (sols) of CeO₂ are added as inorganic UV absorbers.

7. A hybrid polyisocyanate composition according to claim 1, wherein the blocked polyisocyanates D) have NCO functionalities of 2.3 to 4.5, NCO group contents of 11.0% to 24.0% by weight, and monomeric diisocyanate contents of less than 1% by weight.

8. A hybrid polyisocyanate composition according to claim 1, wherein the blocked polyisocyanates D) are based on IPDI, MDI, TDI, 4,4′-diisocyanatodicyclohexylmethane, HDI or mixtures thereof.

9. A hybrid polyisocyanate composition according to claim 1, characterized in that the NCO groups of the blocked polyisocyanates D) are blocked with butanone oxime, caprolactam, malonic esters, diisopropylamine, cyclopentanone-2-carboxyethyl(methyl) ester, isopropanol or mixtures thereof.

10. A coating composition comprising:
a) at least one hybrid polyisocyanate composition according to claim 1; and
b) at least one polyol or polyamine.

11. A method of coating a substrate, comprising forming a mixture comprising
a) at least one hybrid polyisocyanate composition according to claim 1 and
b) at least one polyol or polyamine
and applying the mixture to a substrate.

12. A coating comprising the hybrid polyisocyanate composition according to claim 1.

13. A substrate coated with the coating according to claim 12.
